(19) United States
(12) Patent Application Publication
(10) Pub. No.: US 2014/0074865 A1
(43) Pub. Date: Mar. 13, 2014

(54) IDENTIFYING VEHICLE SYSTEMS USING VEHICLE COMPONENTS

(71) Applicants: Nate Zobrist, Orem, UT (US); Marcus Isaac Daley, Erie, CO (US); Charles Martin Bergquist, Apple Valley, MN (US); Kent Charles Klingensmith, Eden Prairie, MN (US)

(72) Inventors: Nate Zobrist, Orem, UT (US); Marcus Isaac Daley, Erie, CO (US); Charles Martin Bergquist, Apple Valley, MN (US); Kent Charles Klingensmith, Eden Prairie, MN (US)

(73) Assignee: SERVICE REPAIR SOLUTIONS, INC., Las Vegas, NV (US)

(21) Appl. No.: 13/608,355

(22) Filed: Sep. 10, 2012

(51) Int. Cl. G06F 17/30

(52) U.S. Cl. 707/749; 707/758; 707/E17.014

(57) ABSTRACT

Embodiments of a repair correlation system are described, wherein the repair correlation system identifies related vehicle repairs based on key parts (or the most important parts) of an automotive sub-system. The repair correlation system can use a database or other data repository of matching parts to identify related automotive sub-systems (e.g., engine, transmission, etc.) by matching key parts for sub-systems across different brands and models. For example, the repair correlation system can determine that repairs for a first engine with key parts A, B, and C are applicable to a second engine with the same key parts. Thus, an engine in a Honda car and an engine in a Ford car could be identified by the system as having co-applicable repair data based at least partly on the key parts matching, even though the engines are used by different brands and models.

### BACKGROUND

This disclosure generally relates to systems and methods for identifying vehicle repairs, and more particularly, correlating repairs for similar vehicle systems across different vehicle models.

### DESCRIPTION OF THE RELATED ART

Automobiles have many components and systems that function alone, or in coordination, to allow proper operation of the vehicle. Examples of such systems and components may include, but are not limited to, engine systems, brake systems, emissions systems, transmission systems, belts, hoses, fluid levels, tires, etc. Because automobiles have many systems and components, some of which affect the operation of other systems and components, diagnosing problems and identifying repairs or fixes for those problems can be difficult.

Some entities, such as vehicle manufacturers or repair facility operators, track repair information in order to aid in diagnosing vehicle problems. In some cases, these entities share this repair information. For example, vehicle manufactures provide vehicle repair manuals for common vehicle repairs and issue technical service bulletins (TSBs) that recommend procedures for repairing vehicles. Such TSBs can range from vehicle-specific to covering entire product lines and break down the specified repair into a step-by-step process.

### SUMMARY

In some embodiments, a repair correlation system (RCS) correlates repair data across different vehicles (e.g., different models, manufacturers, model years, etc.) based at least partly on the identification of parts that are in common between systems of the different vehicles. The repair correlation system can respond to requests for repair data for a particular vehicle with a response that includes repair data for other vehicles that have been identified as having an identical or similar system. In some embodiments, the repair correlation system may provide a confidence ranking to the repair data based on the similarity of the systems across the different vehicles.

### BRIEF DESCRIPTION OF THE DRAWINGS

FIG. 1 is a block diagram of an embodiment of a repair correlation system that is configured to identify related repairs across different vehicles;

FIG. 2 illustrates a flowchart of an embodiment of a process for correlating repair data across different vehicles;

FIG. 3 illustrates an embodiment of an interface for the repair correlation system of FIG. 1; and

FIG. 4 illustrates an embodiment of an interface to a repair recommendation system, which, in some embodiments, is part of the repair correlation system of FIG. 1.

### DETAILED DESCRIPTION

Many vehicle manufacturers use the same or similar vehicle systems in their vehicle models. For example, a manufacturer often uses the same engine or variations of the engine in different vehicle models. In addition, different manufactures may also use the same or similar systems. For example, different manufactures may source a vehicle system from the same supplier and thus end up with the same or similar systems, even in vehicles that are quite different. However, automobile repair facilities, among others, do not currently have access to information about shared systems. Therefore, disclosed herein are systems and methods of identifying similar vehicle systems in order to provide more complete repair data for repair facilities or other users needing repair data.

In some embodiments, the repair correlation system identifies related vehicle repairs based on key parts (or the most important parts) of an automotive sub-system. The repair correlation system can use a database or other data repository of matching parts to identify related automotive sub-systems (e.g., engine, transmission, etc.) by matching key parts for sub-systems across different brands and models. For example, the repair correlation system can determine that repairs for a first engine with key parts A, B, and C are applicable to a second engine with the same key parts. Thus, an engine in a Honda car and an engine in a Ford car could be identified by the repair correlation system as having co-applicable repair data based at least partly on the key parts matching, even though the engines are used by different brands and models. For example, the repair correlation system can respond to a search for “1998 Chrysler Town and Country engine problem” by first determining that the engine used in the 1998 Chrysler Town and Country has key parts A, B, and C, and then returning results having all (or some large portion of) these components, such as:
Result 1: Repair data for Town and Country engines where the engine has key parts A, B, & C;
Result 2: Repair data for other Chrysler model engines that have engines with key parts A, B & C; and/or
Result 3: Repair data for Honda Odyssey engine that have engines with key parts A, B & C.

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the systems and methods herein described.

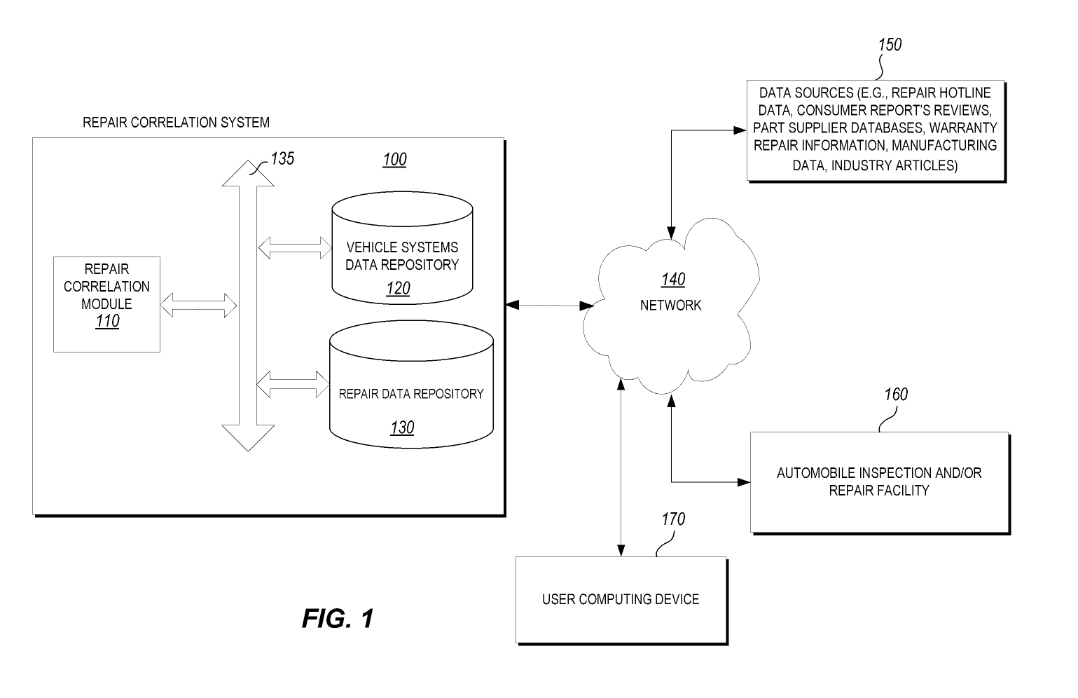

FIG. 1 is a block diagram of an embodiment of a repair correlation system 100 that is configured to identify related repairs across different vehicles. The repair correlation system 100 can include one or more CPUs (central processing units) or computing devices, a repair correlation module 110 for identifying similar vehicle systems across different vehicles and associating repair data for the similar systems, a vehicle systems data repository 120 for vehicle and/or customer related data and a repair data repository 130 for storing repair related data. The components can be connected via a communications medium 135, such as a system bus or network. The repair correlation system 100 components can be part of a single computing device or part of one or more computing systems comprising one or more computing devices.

The repair correlation system 100 can also include a data interface for receiving and/or transmitting data over a communications link. The communications link can be via a wired and/or wireless communication link, such as Ethernet, Bluetooth, 802.11a/b/g/n, infrared, universal serial bus (USB), IEEE 1394 interface, or the like. In some embodiments, repair correlation system 100 connects to a network 140, such as LANs, WANs, and/or the Internet, for communicating with one or more data sources 150, one or more automobile inspection and/or repair facilities 160 (referred to herein as simply the “repair facility 160”), and one or more user computing devices 170. The repair correlation system 100 can also include a web server for serving web pages or other server for providing content to the user computing devices.

In an example scenario, a user (e.g., a repair technician or vehicle owner) is researching possible repair solutions for a problem with a vehicle. The user may specify the make, model, and/or year of the vehicle and the problem in a search interface (e.g., a web application, mobile application, or desktop application interface). For example, the user could enter “1998 Chrysler Town and Country engine problem” into the search interface. In some embodiments, the search interface is part of the repair correlation system 100 and the repair correlation system 100 receives the query directly. In some embodiments, the search interface is part of another application, such as a repair recommendation application, that is in communication with the repair correlation system 100. After receiving the query, the repair correlation system 100 identifies the vehicle system at issue based on the information from the user. For example, the repair correlation system 100 may compare the search query with a list of keywords or otherwise process the search query to identity terms from the search query related to vehicle systems. In some embodiments, the user may specify the vehicle system using a list of vehicle systems (e.g., drop downs or selection lists) or by otherwise providing a selection of a vehicle system to the repair correlation system 100 (e.g., using a vehicle model). In the above example, the repair correlation system 100 can determine the query is related to engines by identifying the keyword “engine.” The repair correlation system 100 can further identify that the vehicle system in question is an engine of a 1998 Chrysler Town and Country. Using this information, the repair correlation system 100 can look up data in the vehicle systems data repository 120 to identify key components of the particular engine.

In some embodiments, the vehicle systems data repository 120 includes information about key parts of respective vehicle systems. In one embodiment, a vehicle expert may determine which parts of a vehicle system are “key parts,” where “key parts” are parts that tend to uniquely identify the vehicle system, allowing the identification of the same or similar systems used in other vehicles. For example, in some embodiments, of the ten or so parts that describe the Antilock Braking System (ABS), the Wheel Speed Sensors and ABS Control Module can be the primary parts that identify the Antilock Braking System (ABS). In some embodiments, of the twenty or so parts that describe the Heating, Ventilation and Air Conditioning system (HVAC), HVAC Control Panel, HVAC Control Module, In-Car Temperature Sensor and Mode Door Actuator can be the primary parts that identify the Heating, Ventilation and Air conditioning system (HVAC). In some embodiments, of the two parts that describe the Tire Pressure Monitoring System (TPMS), both the Tire Pressure Sensors and the Tire Pressure Monitoring Module may be used to identify the Tire Pressure Monitoring System (TPMS) system.

The above examples are based at least partly on interviews with automotive repair subject matter experts and the key parts identified by the experts based on their professional experience. In some embodiments, other methods can be used to identify the key parts, such as by using Repair Frequency Analysis and Cost Analysis. Repair Frequency Analysis identifies the parts in a system that fail most frequently; such failures tend to indicate a high level of usage of the parts, pointing to the parts' importance. In addition, as similar systems (e.g., engines or HVAC) tend to operate in similar manners, the frequency of failure of parts across systems tends to indicate which parts are important to the functioning of the similar systems. Cost Analysis identifies the most expensive parts in a system; such parts tend to play important roles in defining the operation of the system, hence the high cost, and thus may be the key parts of the system.

Key parts may be defined for each category of vehicle systems (e.g., engine, transmission, air conditioning, etc.) and even for particular versions or models of vehicles systems. Preferably, a key part or combination of key parts serves as a “fingerprint” or “DNA” for a particular vehicle system, allowing the system to identify the same or a similar vehicle system.

After determining the key parts for a first vehicle system, the repair correlation system 100, in one embodiment, tries to find other vehicle systems with the same key parts, operating under the assumption that vehicles systems with the same key parts are likely identical or substantially similar. In some embodiments, the repair correlation system 100 searches for other vehicle systems that use the same or similar key parts. In some cases, the repair correlation system 100 may identify matching parts using part numbers, for example, by searching for parts with identical or similar part numbers. For example, the repair correlation system 100 may determine that an engine in a Honda vehicle is identical or at least similar to an engine in an Acura vehicle or a GM vehicle, because the engines in those vehicles have the same or similar components. In some cases, part numbers can change over time due to manufacturer or supplier changes. The changing of the part numbers is sometimes called supersession. Superseded parts are typically considered functionally identical and thus may be considered by the system 100 as identical for purposes of matching key parts. In addition, parts can be considered identical if their specifications are identical. Thus, in one embodiment, the system 100 compares specifications for parts, identifies parts that are equivalent based on their respective specifications, and designates and/or identifies the parts as matching.

After identifying the related system(s), the repair correlation system 100 can associate repairs for those other vehicle systems with the first vehicle system. In one embodiment, the repair correlation system 100 maintains a database or other data structure of vehicle systems and related vehicle systems. The database may be referred to by another system, such as the repair recommendation system, that can use the database to recommend possible repairs that include repairs performed on related vehicle systems. In one embodiment, the repair correlation data between vehicle systems is maintained in the vehicle systems data repository 120.

Referring back to FIG. 1, the repair correlation system 100 can aggregate or retrieve data from one or more data sources 150, which may be accessed through network 140 connections, such as via an Internet connection. The data sources 150 may include data from one or more of repair hotlines, consumer report data providers, automobile parts suppliers, warranty repair providers, manufacturing data, industry articles, and many other providers of data that are relevant to inspections and/or repairs of vehicles. In some embodiments, the data sources 150 include the data sources provided by Automotive Aftermarket Industry Association's (AAIA), such as the Vehicle Database (VCDB), the Parts Categorization Database (PCDB), and the Qualifier Database (QDB). The VCDB is a relational database of vehicle configurations for passenger cars and light trucks sold in the US and Canada organized into vehicle systems or attribute groups, including data on base vehicle and sub-models. The PCDB provides standardized automotive parts nomenclature and a coded, hierarchy of product terminology, allowing the efficient exchange of electronic catalog and product information in the vehicle parts aftermarket. In addition, the repair correlation system 100 may support the AAIA's Aftermarket Catalog Enhanced Standard (ACES) standard or another data standard for the management and exchange of automotive catalog applications data, to provide easier exchange of vehicle data with other systems implementing a common standard.

In addition to transferring relevant recommendation and repair data via the network 140, certain data sources 150 may transmit data to the repair correlation system 100 via other means, such as on a tangible, movable media, such as DVD, CD-ROM, flash memory, thumb drive, etc., that may be delivered to an administrator of the repair correlation system 100. In other embodiments, the repair correlation system 100 is in communication with fewer or more devices than are illustrated in FIG. 1. In one embodiment, certain functionalities described herein with respect to the repair correlation system 100 are performed, partly or completely, by other devices, such as computing devices of one or more data sources 150, computing devices of the repair facility 160, and/or user computing devices 170.

In some embodiments, the repair correlation system 100 obtains vehicle repair data from one or more repair facilities 160. For example, a technician inspects and diagnoses a vehicle and notes any repairs performed and the results of such repairs, such as whether the performed repair solved the problem, failed, and/or whether a different repair was attempted or succeeded. The technician can provide the repair data via an interface to the repair correlation system 100, such as, for example, a software application interface, web page, mobile app or the like. The technician can also provide customer and/or vehicle identification data, such as name, address, VIN number, vehicle mileage, vehicle description, vehicle make/model/year and/or the like. The technician can also provide additional inspection data, such as pictures and/or video of the inspected items, evaluations of the inspected items, repair recommendations, estimates of repair costs, status of the inspected item, customer decisions regarding suggested repairs, and/or updates on previously recorded inspection items from past inspections.

In one embodiment, the repair facility 160 comprises a data repository that stores data associated with vehicles and/or customers, inspections, repairs, and/or repair results, for example, that are performed or observed at the repair facility 160. In one embodiment, the repair facility 160 comprises an automobile repair shop, such as that of a dealership, fleet maintenance depot, or independent mechanic.

The repair correlation system 100 can be located in individual repair facilities, such as the repair facility 160, or may be a centralized or nodal repair correlation system 100 in communication with multiple repair facilities 160. In one embodiment, a repair correlation system 100 operator services multiple repair facilities 160 and provides repair correlation data to users or customers of the repair facilities 160. Users can log in to a web page or other interface provided by the repair correlation system 100 in order to retrieve correlated repair data for a particular vehicle.

The repair correlation system 100 can transmit or provide the repair correlation data to one or more user computing devices 170, such as a computing device that performed a search query upon which the repair data was located. The user computing devices 170 can be a desktop personal computer (PC), a laptop computer, a cellular phone, personal digital assistant (PDA), a kiosk and/or the like. For example, the customer, using his mobile computing device (e.g. a cell phone or tablet) or PC at home or at work, conducts a search for repair procedures that utilizes the repair correlation data from the repair correlation system 100 to identify potential applicable repairs.

### EXAMPLE EMBODIMENTS

In some embodiments, the repair correlation system 100 includes fewer or more components than are illustrated in FIG. 1. For example, the repair correlation system 100 can include a repair recommendation module or other additional modules. In one embodiment, certain functionalities described herein with respect to the repair correlation module 110 are performed, partly or completely, by other components.

In the embodiment of FIG. 1, the repair correlation system 100 can include any combination of software, firmware, and hardware. For example, the repair correlation system 100 may include only software code that may be executed by suitable computing devices (e.g., a computer or server). Alternatively, the repair correlation system 100 may include a computing device, such as a computing device having one or more CPUs, which may each include conventional microprocessors or any other processing unit. In this embodiment, the repair correlation system 100 further includes one or more memory devices, such as random access memory (“RAM”) for temporary storage of information and/or a read only memory (“ROM”) for permanent storage of information, and one or more mass storage devices, such as hard drives, diskettes, or optical media storage devices. In one embodiment, the components of the repair correlation system 100 are in communication via a standards based bus system, such as bus systems using Peripheral Component Interconnect (PCI), Microchannel, SCSI, Industrial Standard Architecture (ISA) and Extended ISA (EISA) architectures and others. In certain embodiments, components of the repair correlation system 100 communicate via one or more networks, such as a local area network that may be secured.

In general, the term “module,” as used herein, refers to logic embodied in hardware or firmware, or to a collection of software instructions, possibly having entry and exit points, written in a programming language, such as C, C# or C++. A software module may be compiled and linked into an executable program, installed in a dynamic link library, or may be written in an interpreted programming language such as BASIC, Perl, or Python. It will be appreciated that software modules may be callable from other modules or from themselves, and/or may be invoked in response to detected events or interrupts. Software instructions may be embedded in firmware, such as an EPROM. The modules described herein are preferably implemented as software modules, but may be represented in hardware or firmware. Moreover, although in some embodiments a module may be separately compiled, in other embodiments a module may represent a subset of instructions of a separately compiled program, and may not have an interface available to other logical program units.

In one embodiment, the repair correlation system 100 comprises a server based system. In other embodiments, the repair correlation system 100 may comprise any other computing device, such as a computing device or server that is IBM, Macintosh, or Linux/Unix compatible. In another embodiment, the repair correlation system 100 comprises a desktop personal computer (PC), a laptop computer, a cellular phone, personal digital assistant (PDA), or a kiosk, for example.

The repair correlation system 100 is generally controlled and coordinated by operating system software, such as server based software. In other embodiments, the repair correlation system 100 comprises modules that execute one or more other operating systems, such as Android, Chrome, iOS, Windows 95, Windows 98, Windows NT, Windows 2000, Windows XP, Windows Vista, Windows 7, Windows Server, Linux, SunOS, Solaris, PalmOS, Blackberry OS, or other mobile, desktop or server operating systems. In Macintosh systems, the operating system may be any available operating system, such as MAC OS X. In other embodiments, the repair correlation system 100 may be controlled by a proprietary operating system. Conventional operating systems control and schedule computer processes for execution, perform memory management, provide file system, networking, and I/O services, and provide a user interface, such as a graphical user interface (“GUI”), among other things.

The repair correlation system 100 can include one or more commonly available input/output (I/O) devices and interfaces (not shown), such as a keyboard, mouse, touchpad, speaker, and printer. In one embodiment, the I/O devices and interfaces include one or more display device, such as a monitor, that allows the visual presentation of data to a user. More particularly, a display device provides for the presentation of GUIs, application software data, and multimedia presentations, for example. The repair correlation system 100 may also include one or more multimedia devices, such as speakers, video cards, graphics accelerators, and microphones, for example.

### EXAMPLE METHODS

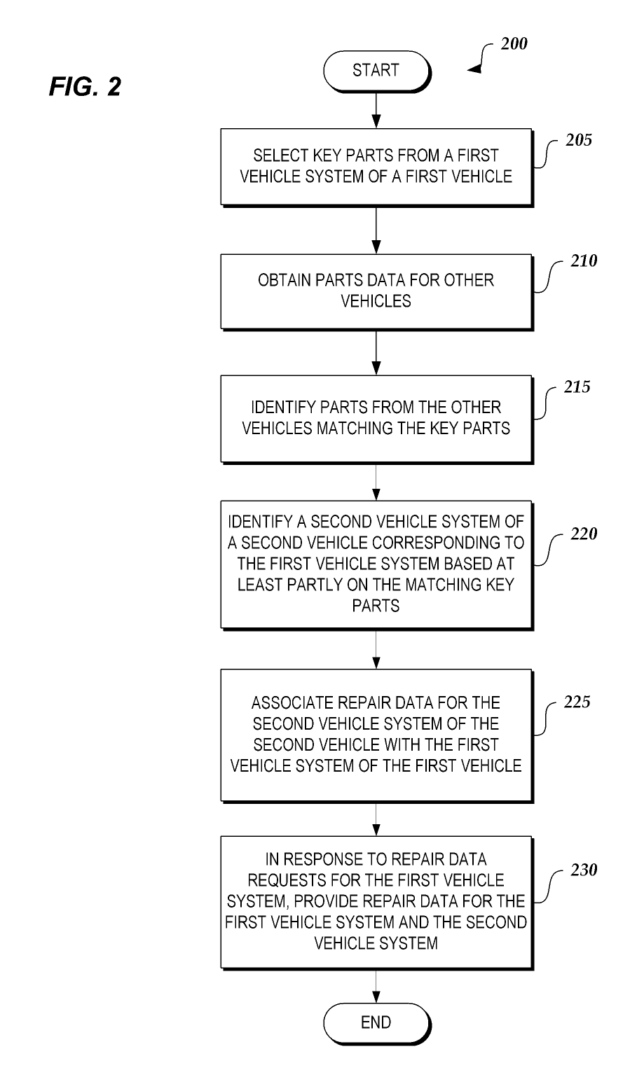

FIG. 2 illustrates a flowchart of an embodiment of a process 200 for correlating repair data across different vehicles. The process can be used, for example, by the repair correlation system 100 or other portions of the systems illustrated in FIG. 1. Depending on the embodiment, the process of FIG. 2 may include fewer or additional blocks and/or the blocks may be performed in a different order than is illustrated. Software code configured for execution on a computing device in order to perform the process of FIG. 2 may be provided on a computer readable medium, such as a compact disc, digital video disc, flash drive, or any other tangible, medium. Such software code may be stored, partially or fully, on a memory device of the repair correlation system 100, in order to perform the process outlined in FIG. 2. For ease of explanation, the method will be described herein as performed by the repair correlation system 100; however, the method may be performed wholly or partially by any other suitable computing device or system.

Beginning at block 205, the repair correlation system 100 selects or identifies key parts from a first vehicle system of a first vehicle. In one embodiment, the key parts are identified based on a data repository of key parts specified by experts, such as the vehicle systems data repository 120 of FIG. 1. For example, the repair correlation system 100 can check the data repository for key parts that have been associated with the first vehicle system, such as by one or more experts. In some embodiments, if no key parts have been identified specifically for the first vehicle system, the repair correlation system 100 may use a default selection of key parts for the type of vehicle system corresponding to the first vehicle system (e.g., default key parts for engine systems).

In some embodiments, the repair correlation system 100 automatically selects the key parts for the first vehicle system even if no existing designations of key parts are specified for the first vehicle system. For example, the system 100 can select key parts by ordering or ranking the key parts of the first vehicle system. In one embodiment, the repair correlation system 100 may order the parts of the first vehicle system based on a selection criterion (e.g., cost, size relative to the system, etc.) and then select the top X (e.g., 1, 2, 3, 4, etc.) parts as the key parts. In some situations, the selection criteria can serve as proxies to the importance of the part to the vehicle system. For example, if important parts of two vehicle systems are the same, then it may be more likely that repairs that are applicable to one vehicle system are also applicable to another system with the same important parts.

At block 210, the repair correlation system 100 obtains parts data for other vehicles. In one embodiment, the system 100 accesses an internal or external data repository (e.g., data sources 150 or vehicle systems data repository 120 of FIG. 1) that includes vehicle parts data. In some embodiments, the repair correlation system 100 obtains parts data for other vehicles from the various data sources 150 and stores the parts data in the vehicle systems data repository 120 of FIG. 1. The repair correlation system 100 can then refer to the parts data when performing parts matching. The parts data can include information on what parts are included in various systems of various vehicles, supersession information for various parts, parts specification data for various parts, part numbers or designations, and/or other information on vehicle parts.

At block 215, the repair correlation system 100 identifies parts from other vehicles matching the key parts identified in block 205. For example, the repair correlation system 100 can search for identical or similar parts numbers for the respective key parts. In some situations, the same parts may be referred to using different part numbers. For example, two different vehicle manufacturers may use different parts numbers for the same part provided by a parts manufacturer. The parts data obtained by the repair correlation system 100 can include data on the different parts numbers that may be assigned to the same part.

In some cases, parts manufacturers will use similar, but not identical part numbers for the same or very similar parts. For example, many parts manufacturers practice supersession in their parts manufacturing and design, where part A is discontinued and replaced by part B, which may in turn be replaced by part C, etc. Supersession can happen when the manufacture develops and releases a new part to replace the old part because the new part is smaller, faster, lighter, more efficient, cheaper to produce and/or stronger. The repair correlation system 100 may track these multiple parts iterations using a supersession chain of A→B→C→D→etc. Each different part likely will have a different part number. However, in some cases, the part numbers may be similar, such as 4868430AF vs. 4868430AE. Thus, in those cases, the repair correlation system 100 may identify close matches of part numbers as likely matching key parts. In some cases, the parts numbers may be significantly different from each other. Thus, in those cases, the repair correlation system 100 can obtain supersession data in order to identify relationships between parts and use the suppression data to identify the different part numbers that are in the same supersession chain. For example, if the key part at issue is part B in the above example, the repair correlation system 100 can look for vehicle systems that use parts A, C, and/or D.

At block 220, the repair correlation system 100 identifies related vehicle system(s) to the first vehicle system based at least partly on the matching key parts. The related vehicle systems can include vehicle systems from different vehicles and different manufacturers. In some cases, there may be no related vehicle systems, one related system or multiple related systems. In some embodiments, the repair correlation system 100 may identify vehicle systems as related with varying levels of certainty using a confidence score. For example, if 4 of 5 key parts match, then the repair correlation system 100 may give a confidence score of 80% (⅘=0.80). In some embodiments, the confidence score may be calculated by weighting some key part matches more than others. For example, the key parts may be weighted by relative costs or importance of the part to the system. By using weighting, the repair correlation system 100 can account for varying levels of effect on the applicability of repairs that differences between key parts may have. For example, if a first vehicle system uses a first part while a second vehicle system uses a second part, but the different parts have little or no effect to the operation of the first vehicle system and the second vehicle system, then the repair correlation system 100 can apply a lower weight to the mismatch of the first part and the second part in calculating the confidence score.

At block 225, the repair correlation system 100 associates repair data for the related vehicle system(s) with the first vehicle system of the first vehicle. In one embodiment, the repair correlation system 100 records or otherwise indicates that the repair data for the related vehicle system is applicable to the first vehicle system because the related vehicle system and the first vehicle system are identical or at least similar. For example, the repair correlation system 100 may alter or add an entry into the vehicle system database 120 to associate the related vehicle system repair data with the first vehicle system.

In some embodiments, the repair correlation system 100 recursively associates repair data. For example, if vehicle system A is related to vehicle system B, which is related to vehicle system C, then the repair correlation system 100 can associate repair data for vehicle system C with vehicle system A. In some embodiments, the repair correlation system 100 may assign a lower confidence score to the repair data for vehicle system C than for vehicle system B because the association is more indirect.

In some embodiments, the repair correlation system 100 performs blocks 210-225 in a background process that periodically identifies associations between vehicle systems of various vehicles and stores those associations for access by various systems wherein such vehicle system associations may be useful. For example, the repair correlation system 100 may maintain a data structure indicating associations between various vehicle systems, confidence scores on any pair of vehicle systems, and/or repair information associated with the various vehicle systems. In other embodiments, the repair correlation system 100 performs the vehicle system matching of blocks 210-225 in a substantially real-time manner, such as in response to a request for repair information for a particular vehicle system.

At block 230, the repair correlation system 100 or another system (e.g., a repair recommendation system) responds to the repair data requests for the first vehicle system by providing or transmitting repair data that includes the associated repair data for the related vehicle system. In some embodiments, the repair correlation system 100 or the recommendation system receives the request from a first computing device over a computer network and responds to the request by transmitting the repair data over the computer network to the first computing device. For example, if a query requests possible repairs to a problem occurring in vehicle system A, the repair correlation system 100 can respond with repair data for vehicle system A and related vehicle system B, even if vehicle system B is a different vehicle made by a different manufacturer. By responding with the associated repair data, the repair correlation system 100 can broaden the pool of available repair data while maintaining a high level of relevancy in the suggested repairs. Thus, a user of the repair correlation system 100 may be more likely to find an applicable repair procedure even if that repair procedure was intended for a different vehicle. The process 200 can then end.

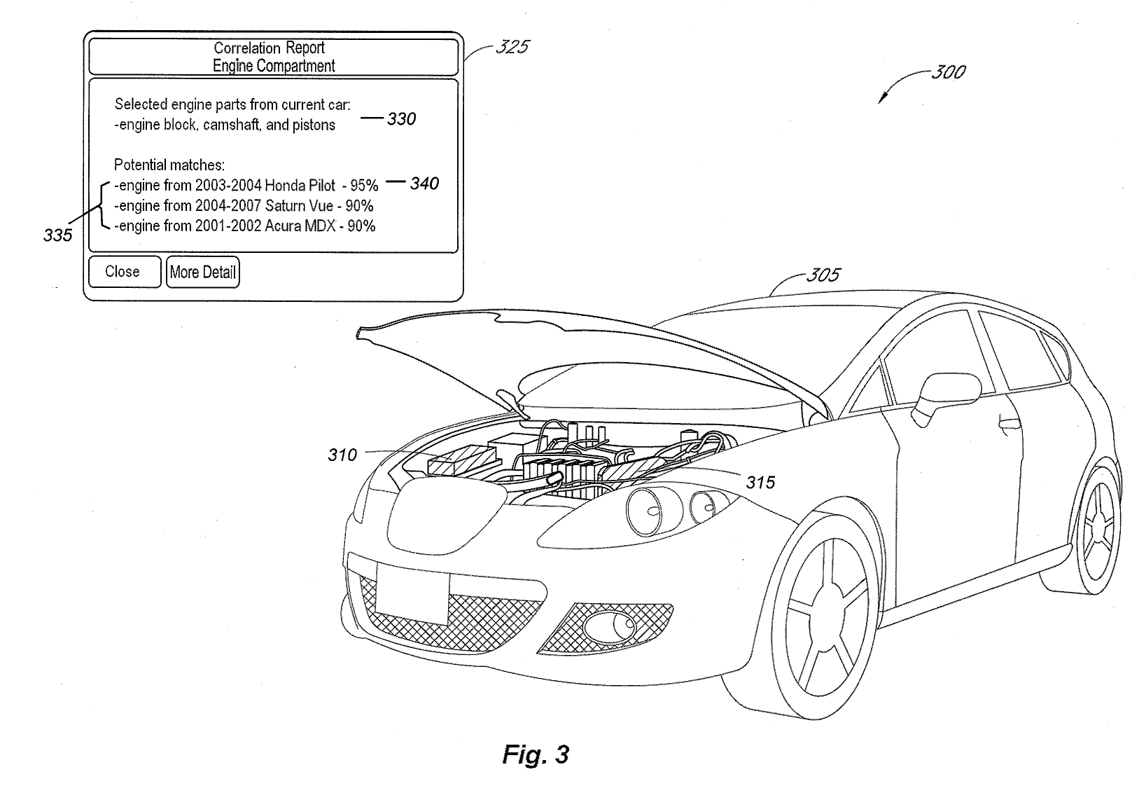

FIG. 3 illustrates an embodiment of an interface 300 for the repair correlation system 100 of FIG. 1. The interface can allow a user, such as an administrator or expert, to interact with the repair correlation system 100 system in order to define key parts and/or review associations between key parts. In some embodiments, the interface 300 is part of a web application, desktop application or mobile app. The interface 300 can include a model 305 (e.g., a 3-dimensional or 2-dimensional model) of a vehicle to illustrate to the user the key parts of the system. For example, in the illustrated embodiment, two key parts 310, 315 are shown. In some embodiments, the user can specify the key parts for a vehicle system by selecting parts on the model. In some embodiments, the user can specify key parts using other inputs, such as text fields, buttons, selection lists or the like.

The interface 300 can also include a correlation report 325 that shows the results of correlation analysis performed by the repair correlation system 100. In the illustrated sample report 325, the user has specified as key parts 330 the engine block, the camshaft, and pistons of a first vehicle. The repair correlation system 100 then identifies potential matching systems 335 in other vehicles. In the sample report, the repair correlation system 100 identifies the 2003-2004 Honda Pilot, the 2004-2007 Saturn Vue, and the 2001-2002 Acura MDX as vehicles potentially having matching engine systems to the first vehicle based on matching the key parts of the engine systems. In some embodiments, the repair correlation system 100 can also provide a confidence score 340 for each of the potential matches it identifies.

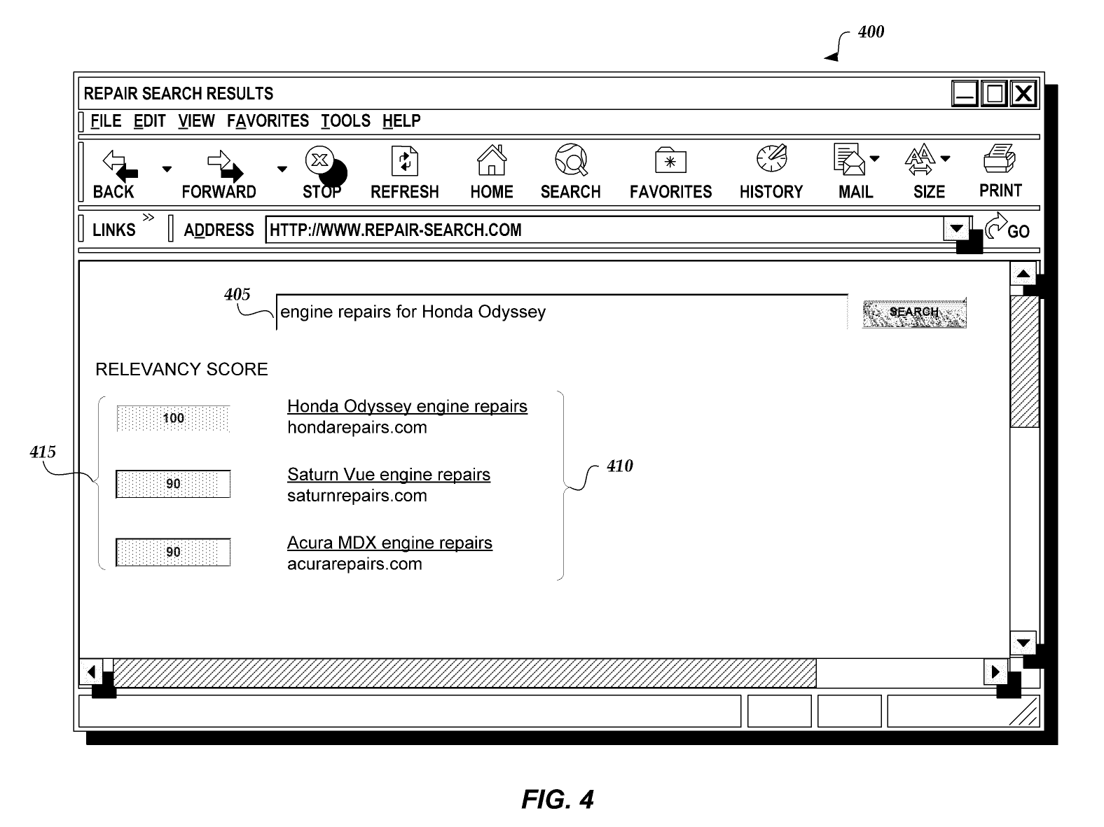

FIG. 4 illustrates an embodiment of an interface 400 to a repair recommendation system. The interface 400 can be a web application interface or other application interface. In some embodiments, the repair recommendation system is a part of the repair correlation system 100 or utilizes repair correlation data between vehicle systems generated by the repair correlation system 100. The repair recommendation system can respond to requests for repair data for a first vehicle system with repair data from the related vehicle systems.

As illustrated in FIG. 4, a user is searching for “engine repairs for Honda Odyssey” by entering in the search into a text field 405 or other input of the interface 400. The repair recommendation system can identify keywords in the search in order to determine related vehicle systems. For example, the repair recommendation system can use the keywords “Honda Odyssey” and “engine” to identify the relevant vehicle system and vehicle. With this information, the repair recommendation system can respond to the repair request with possible fixes using repair data for a Honda Odyssey engine system and repair data from vehicle systems related to the Honda Odyssey engine system. For example, the illustrated interface 400 provides the users with repair recommendations 410 or links to potential fixes determined using repair data for the Honda Odyssey as well as for vehicles with related engine systems, such as the Saturn Vue and the Acura MDX.

In some embodiments, the interface 400 may also display confidence scores 415 or relevancy scores associated with the provided repair data. Such scores can be calculated as described above and can be used to indicate to the user how applicable the repair data may be to the original query posed by the user. In some embodiments, details regarding the confidence scores may be provided, such as in a pop-up window that appears when a cursor hovers over a displayed confidence score. For example, the further details may provide part numbers that were matched (and/or that are similar), manufacturer information that was matched, and/or any other specific information that was used in identifying vehicle systems of other vehicles as relevant.

While the repair correlation system 100 has been described in reference to repair recommendations, it will be apparent that the systems and processes described above can be useful in a variety of situations. For example, the repair correlation system 100 can be used to identify compatible vehicle systems that can be the source of replacement parts for a particular vehicle system. In addition, the techniques described above for finding related repairs can be used more generally for finding relevant data. For example, the repair correlation system 100 can also associate cost data, parts source data or other data between different vehicles, in addition to repair data. Further, the techniques described above can also be applied to other industries. For example, repair data for electronic devices or appliances, such as smart phones, televisions, or computers, could be associated with each other based on identical or similar sub-systems being used.

Depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the disclosure described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A system for identifying repair recommendations for vehicle systems, the system comprising:
one or more computer processors configured to execute software modules including:
a repair correlation module configured to:
identify key parts of a first vehicle system of a first vehicle;
identify one or more related vehicle systems from one or more vehicles different from the first vehicle by matching the key parts of the first vehicle system with corresponding parts in the one or more related vehicle systems; and
associate the one or more related vehicle systems with the first vehicle system;
a repair recommendation module that responds to repair recommendation requests, the repair recommendation module configured to:
receive a request for repair recommendations for the first vehicle system of the first vehicle;
obtain repair data for the first vehicle system;
obtain repair data for the one or more related vehicle systems associated with the first vehicle system; and
generate one or more repair recommendations based at least partly on the repair data for the one or more related vehicle systems and the repair data for the first vehicle system.

2. The system of claim 1, wherein the first vehicle and the one or more related vehicles are produced by different manufacturers.

3. The system of claim 1, wherein the first vehicle and the one or more related vehicles are different vehicle models produced by a first manufacturer.

4. The system of claim 1, wherein the repair recommendation module assigns a confidence score to a first repair recommendation based at least partly on a level of similarity between the matched key parts of the first vehicle system and the corresponding parts in the related vehicle system from which the first repair recommendation is derived.

5. The system of claim 1, wherein the repair recommendation module assigns a confidence score to a first repair recommendation based at least partly on a number of key parts of the first vehicle system having a match with the corresponding parts in the related vehicle system from which the first repair recommendation is derived.

6. The system of claim 1, further comprising a data repository storing parts data and repair data for vehicle systems for multiple vehicles.

7. The system of claim 1, wherein said matching the key parts of the first vehicle system with corresponding parts in the one or more related vehicle systems comprises comparing part numbers of the key parts to part numbers of the corresponding parts.

8. The system of claim 1, wherein the repair correlation module is configured to identify the key parts of the first vehicle system of the first vehicle by:
identifying one or more vehicles similar to the first vehicle; and
selecting key parts of the first vehicle system based at least partly on key parts of one or more corresponding systems of the similar vehicles.

9. The system of claim 1, wherein the repair correlation module is configured to identify the key parts of the first vehicle system of the first vehicle based at least partly on user designated key parts of the first vehicle system.

10. The system of claim 1, wherein the repair recommendation module is configured to generate the one or more repair recommendations by:
identifying an issue with the first vehicle system based on the request for repair recommendations;
identifying a first solution to the issue with the first vehicle system based on the repair data for the first vehicle system;
identifying a second solution to the issue with the first vehicle based on repair data for the one or more related vehicle systems associated with the first vehicle system; and
providing the first solution and the second solution in the one or more repair recommendations.

11. A method for identifying repair recommendations, the method comprising:
receiving a request for information regarding a first vehicle;
determining a first vehicle system associated with the request;
accessing a data structure storing associations between vehicle systems of various vehicles, the associations determined based on matching key parts of respective vehicle systems;
selecting, from the data structure, one or more related vehicle systems that are associated with the first vehicle system, the one or more related vehicle systems from one or more vehicles different from the first vehicle;
obtaining repair data for the one or more related vehicle systems from a repair data repository; and
providing the obtained repair data to an entity that requested the information regarding the first vehicle.

12. The method of claim 11, further comprising:
associating, in a data repository, the repair data for the one or more related vehicle systems with the first vehicle system.

13. The method of claim 12, wherein said associating the repair data comprises linking the repair data for the one or more related vehicle systems with the first vehicle system in the data repository.

14. The method of claim 11, wherein said matching key parts of respective vehicle systems comprises comparing matching part numbers.

15. The method of claim 11, wherein key parts of the first vehicle system of the first vehicle are selected based on user designations of key parts of the first vehicle system.

16. The method of claim 11, wherein said receiving the request comprises receiving the request from a first computing device over a computer network and said providing the obtained repair data comprises transmitting the obtained repair data to the first computing device over the computer network.

17. Non-transitory computer storage having stored thereon instructions that, when executed, direct a computing system to:
receive a request for information regarding a first vehicle;
determine a first vehicle system associated with a request;
access a data structure storing associations between vehicle systems of various vehicles, the associations determined based on matching key parts of respective vehicle systems;
select, from the data structure, one or more related vehicle systems that are associated with the first vehicle system, the one or more related vehicle systems from one or more vehicles different from the first vehicle;
obtain repair data for the one or more related vehicle systems from a repair data repository; and
provide the obtained repair data to an entity that requested the information regarding the first vehicle.

18. The non-transitory computer storage of claim 17, wherein the instructions direct the computing system to associate the repair data with the first vehicle system by linking the repair data with the first vehicle system in a data repository.

19. The non-transitory computer storage of claim 17, further comprising instructions that direct the computing system to, in response to a request for a repair recommendation for the first vehicle, determine a responsive repair recommendation based at least partly on the repair data for the one or more related vehicle systems from the one or more vehicles different from the first vehicle.

20. The non-transitory computer storage of claim 19, further comprising instructions that direct the computing system to determine the responsive repair recommendation by:
identifying an issue with the first vehicle system based on the request for repair recommendations;
identifying a first solution to the issue with the first vehicle system based on the repair data for the first vehicle system;
identifying a second solution to the issue with the first vehicle based on repair data for the one or more related vehicle systems associated with the first vehicle system; and
including the first and second solution in the responsive repair recommendation.

21. The non-transitory computer storage of claim 17, wherein the instructions direct the computing system to provide the obtained data to the entity by transmitting the data over a computer network to a computing device associated with the entity.
